(19) United States
(12) Patent Application Publication
(10) Pub. No.: US 2009/0184217 A1
(43) Pub. Date: Jul. 23, 2009

(54) STAND SYSTEM FOR HOLDING PARTS, SUCH AS AUTOMOBILE PARTS, DURING PAINTING

(76) Inventor: James M. Sprout, Zimmerman, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/357,903

(22) Filed: Jan. 22, 2009

Related U.S. Application Data
(60) Provisional application No. 61/023,027, filed on Jan. 23, 2008.

(51) Int. Cl. F16M 11/12; B62B 3/02

(52) U.S. Cl. 248/124.1; 280/35

(57) ABSTRACT

A painting stand system for support various forms of vehicle body parts or accessories for painting. The system includes a base unit and at least one mounting unit removably assembled to an upright post of the base unit. Available mounting units include a pivotable mounting units to which a variety of different auxiliary support devices are assembled and pivotably maintained, with the support device(s) configured for optimal use with certain body part formats. Other tools or holding devices, such as clamps and hanging bars, are optionally also included with the system.

### CROSS-REFERENCE TO RELATED APPLICATIONS

This application claims priority under 35 U.S.C. §119(e)(1) to U.S. Provisional Patent Application Ser. No. 61/023,027, filed Jan. 23, 2008, entitled “Stand for Holding Parts, Such as Automobile Parts, During Painting”, and bearing Attorney Docket No. S608.101.101; and the entire teachings of which are incorporated herein by reference.

### FIELD

The disclosure relates to devices useful when applying paint to automobile, truck, van or other vehicle parts and accessories. The disclosure relates more particularly to devices known generally as painting stands for use in supporting automotive parts, accessories, or the like during the painting process.

### BACKGROUND

In facilities that engage in the repair of automobile exteriors, the object of the repair is to duplicate the original manufacturer's finish. It is sometimes necessary to remove and paint parts off of the vehicle (on a painting stand). When this is done, the entire part can be painted, inside and out, preventing any tape lines which helps prevent rusting and ensures a quality look and finish. After painting, the parts are re-assembled on the vehicle, giving it the appearance that the vehicle was never damaged. Known painting stands, while viable, do not allow the user to support the variety of different parts typically encountered (e.g., door, hood, bumper, etc.) in a manner that permits convenient access to all desired surfaces.

### SUMMARY

Accordingly, it is a general object of the present disclosure to provide an improved painting stand for vehicle parts. It is a more particular object of the present disclosure to provide an improved painting stand, or painting stand system, for vehicle parts that is versatile and effective in holding many different parts, especially common automobile parts, of different sizes and shapes.

In accordance with the present disclosure, there is provided a painting stand system for supporting one or more vehicle body parts and/or accessories for spray painting. The stand system includes in some embodiments, a base unit, a pivotable mounting unit, and at least one auxiliary support device. The base unit includes a platform frame assembly and an upright post. The upright port extends from the platform frame assembly and defines an inner face. Within this inner face, a plurality of openings and an elongated slot are formed. The pivotable mounting unit includes a housing, at least one finger, a mounting bar, and a locking mechanism. The housing forms arcuately arranged notches, with the finger extending from the housing and being sized for selectively engagement with respective ones of the openings and/or the slot of the upright post. The mounting bar is pivotably assembled to, and extends from, the housing in a direction opposite the finger, and terminates at a leading end. The locking mechanism selectively secures the mounting bar relative to the housing at respective ones of the notches. With this construction, the pivotable mounting unit is removably mounted to, and supported by, the upright post at a plurality of vertical locations via insertion of the finger into a selective one of the openings or the slot. Finally, the auxiliary support device is selectively coupled to the mounting bar, and is configured to support a vehicle body part. In this regard, the auxiliary support device can assume a variety of forms, such as a bumper cover holding assembly, a bumper hanging assembly, a hood hanging assembly, a fender mounting assembly, etc. In some embodiments, the painting stand system includes two or more different auxiliary support devices, each of which is removably mountable to the mounting bar. In other embodiments, additional mounting units can be provided that are each selectively assembleable to the base unit, such as a door mounting unit, a fixed holder unit, and/or a stabilizer unit.

The attachment(s), unit(s), support device(s), and/or pivoting bracket(s) useful with systems of the present disclosure can assume various forms, and can include one or more of door hanging rods with a straight threaded door attachment and a ninety degree threaded attachment; a pivoting bracket and extension arm with a spring loaded release mechanism that is adjustable to, for example, five different positions and is removable for holding parts and other attachments that hold parts; a cross member that mounts to the pivoting arm on the pivoting bracket and is adjustable and has adjustable bars with removable attachments that extend from both ends for mounting a plurality of parts; a “T” shaped bar that inserts into the end of the extension arm of the pivoting bracket to hold bumpers and clamps that mount to the ends of the extensions in the cross member that hold the ends of the bumper; a hood retention assembly including a hood extension bar and a release handle extension, the hood extension bar forming holes to hold mounting fixtures and a hole that lines up with the extension arm that accepts a pin to assure it is in correct placement to allow the release handle extension to fit into the spring loaded release mechanism that in turn allows the pivoting bracket to be set at different angles; threaded metal rods and a locking clamp for attaching parts to the hood extension bar and the adjustable cross member; a fender mounting bracket consisting of a long center bar that supports four bars in the shape of a square and one bar that extends downward from the center bar with adjustable rods for supporting the lower portion of fender outward from the stand; pickup truck tailgate attachments that mount to the cross members adjustable bars.

### BRIEF DESCRIPTION OF THE DRAWINGS

FIG. 1 is a perspective view of a base unit in accordance with principles of the present disclosure as useful as part of a painting stand system;

FIG. 2A is a side view of a door mounting unit useful as part of a painting stand system in accordance with principles of the present disclosure;

FIG. 2B is a perspective view illustrating use of the door mounting unit of FIG. 2A assembled to the base unit of FIG. 1 and maintaining a door for painting;

FIG. 3A is a simplified side view of a pivotable mounting unit useful as part of a painting stand system in accordance with principles of the present disclosure;

FIG. 3B is a perspective view of the pivotable mounting unit of FIG. 3A assembled to the base unit of FIG. 1;

FIG. 4A is a simplified perspective view of an extendable support device useful as part of a painting stand system in accordance with principles of the present disclosure;

FIG. 4B is a perspective view of the extendable support device of FIG. 4A assembled to the combined base unit of FIG. 1 and the pivotable mounting unit of FIG. 3A;

FIG. 5A is a simplified perspective view of a spring clamp tool useful as part of a painting stand system in accordance with principles of the present disclosure;

FIG. 5B is a simplified perspective view of a tail gate hanging tool useful as part of a painting stand system in accordance with principles of the present disclosure;

FIG. 5C is a front view of a swivel mounting rod assembly tool useful as part of a painting stand system in accordance with principles of the present disclosure;

FIG. 5D is a side view of the tool of FIG. 5C;

FIG. 6 is a perspective view of a bumper hanging assembly support device useful as part of a painting stand system in accordance with principles of the present disclosure, along with the combined base unit of FIG. 1 and the pivotable mounting unit of FIG. 3A;

FIG. 7 is a perspective view of a hood hanging assembly support device useful as part of a painting stand system in accordance with principles of the present disclosure, along with the combined base unit of FIG. 1 and the pivotable mounting unit of FIG. 3A;

FIG. 8A is a simplified side view of a hood mounting rod tool useful as part of a painting stand system in accordance with principles of the present disclosure;

FIG. 8B is a simplified side view of a locking pliers useful as part of a painting stand system in accordance with principles of the present disclosure;

FIG. 8C is a simplified side view of a pivoting holding device tool useful as part of a painting stand system in accordance with principles of the present disclosure;

FIG. 9 is a perspective view of a fender mounting assembly support device useful as part of a painting stand system in accordance with principles of the present disclosure, along with the combined base unit of FIG. 1 and the pivotable mounting unit of FIG. 3A;

FIG. 10 is a perspective view of a fixed holder mounting unit useful as part of a painting stand system in accordance with principles of the present disclosure, along with the base unit of FIG. 1; and

FIG. 11 is a perspective view of a stabilizer mounting unit useful as part of a painting stand system in accordance with principles of the present disclosure, along with the base unit of FIG. 1.

### DETAILED DESCRIPTION

The present disclosure provides a painting stand system useful in supporting various body parts and/or accessories of a vehicle during a painting process. In general terms, the painting stand system includes a base unit to which one or more mounting units that can be removably assembled to, and supported by, the base unit, with the mounting unit(s) being configured to maintain certain vehicle body part(s) for which painting is commonly required. One or more additional, auxiliary support devices can also be provided that assist in maintaining the various vehicle body parts and/or accessories at levels or orientations desired by the user. With this construction, the painting stand systems of the present disclosure are uniquely capable of facilitating convenient painting of virtually all vehicle body parts or accessories, with the various mounting units and auxiliary support devices being quickly and easily assembled to, and removed from, the base unit.

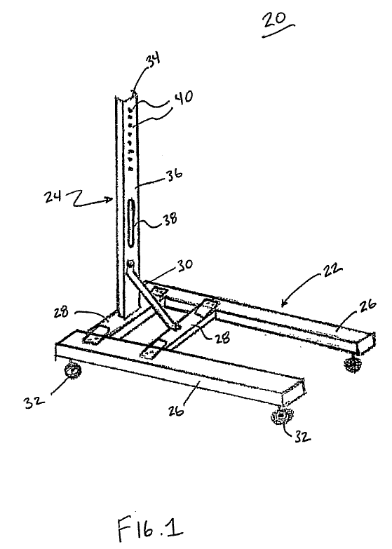

With the above in mind, FIG. 1 illustrates one embodiment of a base unit 20 useful as part of a painting stand system in accordance with the present disclosure. The base unit 20 includes a platform frame assembly 22, and an upright post 24.

The platform frame assembly 22 can assume a variety of forms, and is generally constructed to support the base unit 20 in the presence of moment forces generated by various vehicle body parts (not shown, but, for example, doors, bumpers, hoods, fenders, etc.), otherwise mounted to the upright port 24 as described below. That is to say, the platform frame assembly 22 is constructed to prevent tipping of the painting stand system during use. With this in mind, the platform frame assembly 22 is made of steel or other rigid material of equivalent strength and can include opposing base members 26, one or more cross-bars 28, and a post mounting bracket 30. The post mounting bracket 30 supports the upright post 24 in a vertical position relative to the cross-bar(s) 28. The base unit 20 (and thus the entire painting stand system) can be supported by a plurality of casters 32 that allow the painting stand system to be moved by rolling.

In some constructions, the upright post 24 extends from the frame assembly 22 to an upper end 34. For reasons made clear below, the upright post 24 can be U-shaped in cross-section or tubular, such that the upper end 34 defines a passage or opening for receiving various other components. The upright post 24 can include or form various features for releasably receiving the various attachment accessories described below. For example, relative to an inner face 36, the upright post 24 can form a slot 38 and a plurality of openings or holes 40. The slot 38 is elongated (e.g., has a length greater than a diameter of the respective holes 40), and is disposed between the holes 40 and the frame assembly 22. The holes 40, in turn, have identical diameters, and are vertically aligned proximate the upper end 34. As described below, the slot 38 and the openings 40 facilitate releasable attachment of one or more mounting units to the upright post 24 at a vertical elevation desired by a user, with rigid fixation between the upright post 24 and the frame assembly 22 fully supporting the mounting unit(s) and any vehicle body part(s) maintained thereby.

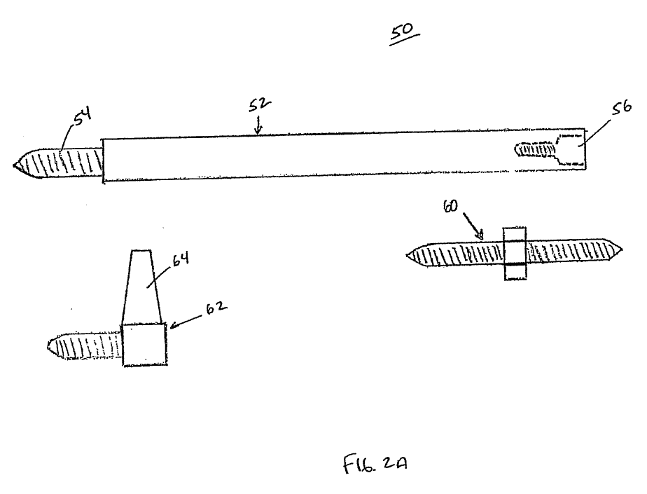

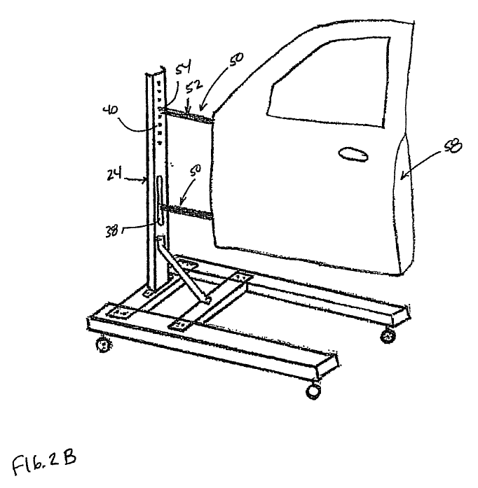

One mounting unit useful with the base unit 20 is a door mounting unit 50 shown in FIG. 2A. The door mounting unit 50 includes a rod 52 that that has a threaded end or portion 54 that is insertable into the slot 38 or one of the holes 40 in the upright post 24 (FIG. 1) and secured with a threaded nut. An opposite end or portion 56 of the rod 52 is a female thread (e.g., threaded bore) most common to threaded studs on vehicle doors.

During use, and with additional reference to FIG. 2B, the female end 56 (hidden in FIG. 2B) is threaded over the upper and lower hinge studs on a car door 58. Then, the male end 54 of the rod 52 is mounted to the upright post 24. With one door mounting unit 50 attached to the upper hinge stud of the door 58, and a second unit 50 to the lower hinges, the door 58 can be mounted to the post 24.

As further shown in FIG. 2A, the door mounting unit 50 can further include an attachment 60 as an adapter for doors with a female thread for the hinge bolts. The attachment 60 is threaded into the female end 56 of the rod 52 then threaded into the hinge bolt hole on the door 58. When this is on both upper and lower hinge holes on the car door 58, it can be mounted to the upright post 24. Further, some door hinges are mounted on a pin, in this instance an adapter 62 can be provided with the door mounting unit 50. The adapter 62 is threaded into the female end 56 of rod 52, and includes a fitting 64 arranged ninety degrees to the rod 52 that is inserted into the pin hole (not shown) on the door hinge then secured with a nut to prevent the door 58 from swinging. With the rod 52 and the adapter 62 secured to each door hinge, the door 58 can be mounted to the upright post 24. When mounting the door 58 to the upright post 24, there will be two mounting units 50 attached to the door 58, the “upper unit” will mount into one of the holes 40 and the “lower unit” will mount within the center slot 38.

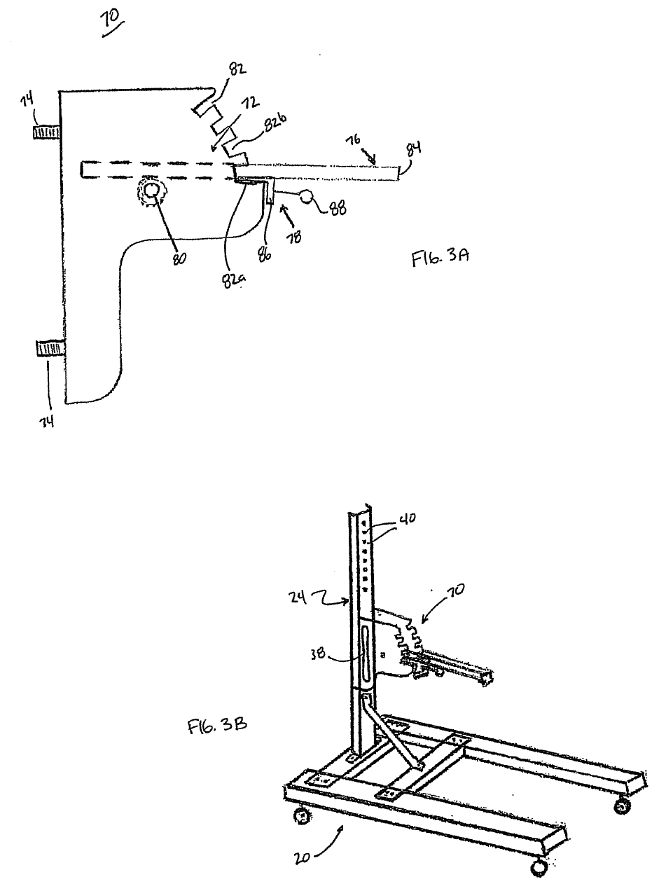

Another mounting unit useful with the base unit 20 as part of a painting stand system in accordance with the present disclosure is a pivotable mounting unit 70 shown in FIG. 3A. The pivotable mounting unit 70 includes a housing 72, one or more fingers 74, a mounting bar 76, and a locking mechanism 78. The housing 72 is made, for example, of two steel plates secured about three inches apart with metal strips. The housing 72 maintains the mounting bar 76 via a pivot bolt 80, and forms arcuately arranged notches 82. The finger(s) 74 project from the housing 72, and are configured for releasable mounting to the upright post 24 (FIG. 1) as described below. For example, the finger(s) 74 can be a threaded bolt.

The mounting bar 76 extends from the housing 72 opposite the finger(s) 74, and terminates at a leading end 84. The mounting bar 76 is formed of a strong, rigid material (e.g., stainless steel, iron, etc.), and in some construction is tubular, forming a square or rectangle in transverse cross-section. Regardless, the locking mechanism 78 selectively secures the mounting bar 76 relative to the housing 72 at various angular orientations via interface with the notches 82. For example, the locking mechanism 78 can include a pin or catch 86 and a biasing device (not shown) such as a spring. The catch 86 is slidably coupled to mounting bar 76, and is biased by the biasing device into contact with the housing 76 (i.e., leftward relative to the orientation of FIG. 3A). In this regard, the catch 86 can include or form an engagement member 88 (e.g., an eye bolt) that facilitates manipulation (e.g., application of a pulling force) of the catch 86 by a user.

This construction allows the mounting bar 76 to be locked at different angles relative to the housing 72 via the notches 82. For example, relative to the arrangement of FIG. 3A, the catch 86 can be released from the notch 82a and the mounting bar 76 rotated, pivoting about the pivot bolt 80 (e.g., relative to the arrangement of FIG. 3A, the mounting bar 76 can be rotated counter-clockwise); once the desired spatial orientation or angle of the mounting bar 76 is achieved, the catch 86 is allowed to re-engage (via the biasing device) a corresponding notch 82b, thereby locking the mounting bar 76 at the selected angle.

The pivotable mounting unit 70 can be assembled to the base unit 20 at various vertical positions, as reflected in FIG. 3B. In this regard, the bolts 74 (FIG. 3A) are inserted into respective ones of the holes 40 and/or the slot 38. In this regard, where two (or more) of the bolts 74 are provided, a vertical spacing between the bolts 74 corresponds with spacings between various ones of the holes 40. Where desired, the pivotable mounting unit 70 can similarly be assembled to the upright post 24 along the slot 38. In either case, the bolt(s) 74 have a threaded end such that a nut (not shown) can be employed to lock the pivotable mounting unit 70 to the upright post 24 be threaded engagement with the corresponding bolt 74. Other constructions can also be employed for facilitating releasable connection or assembly of the pivotable mounting unit 70 with the upright post 24. For example, the housing 72 can form hanger features that are slidably received within corresponding side slots formed in the upright post 24.

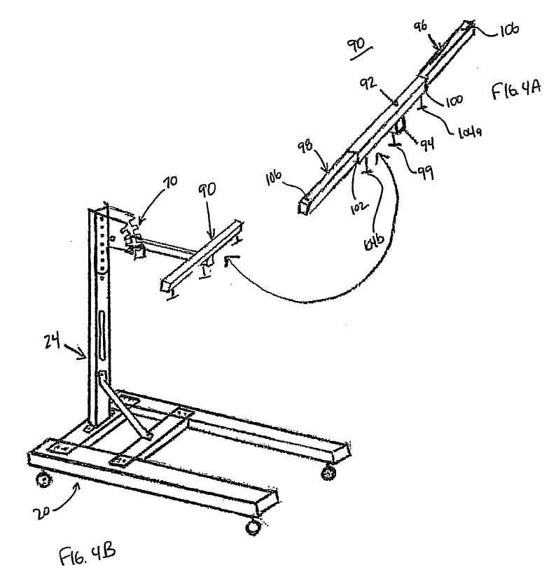

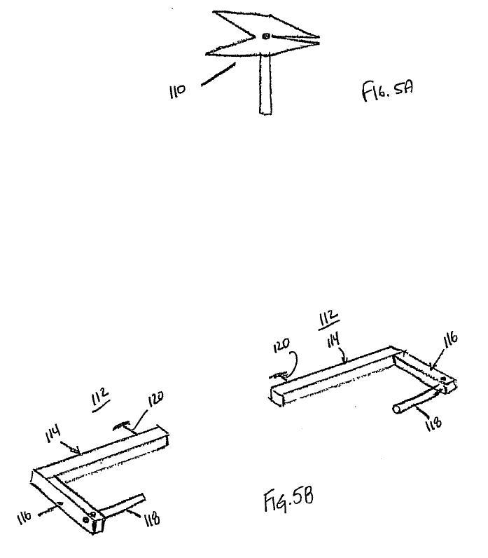

The painting stand system of the present disclosure can include one or more auxiliary support devices useful with, and assembleable to, the mounting bar 76 of the pivotable mounting unit 70. Where two or more different auxiliary support devices are provided, the system is configured such that the desired auxiliary support device is quickly assembled to the mounting bar 76, and can easily be removed and replaced by a different auxiliary support device. With this in mind, FIG. 4A illustrates one auxiliary support device envisioned by the present disclosure in the form of an extendable support device 90. The extendable support device 90 includes a center rod 92, a coupling member 94, and first and second extension arms 96, 98. The coupling member 94 is mounted to the center rod 92, and is configured to slidably receive the mounting bar 76 (FIG. 3A). For example, the coupling member 94 can define an inner diameter slightly greater than an outer diameter of the mounting bar 76, and can include a t-bolt 99 that serves to lock the coupling device 94 relative to the mounting bar 76. Regardless, the center rod 92 defines first and second ends 100, 102. The first extension arm 96 is slidably received within the center rod 92, extending from the first end 100; the second extension arm 98 is similarly slidably received within the center rod 92, extending from the second end 102. T-bolts 104a, 104b can be provided that selectively lock the extension arms 96, 98 relative to the center rod 92. With this construction, then, an overall length of the extendable support device 90 can be varied by simply sliding one or both of the extension arms 96 and/or 98 inwardly or outwardly relative to the center rod 92. Removable assembly of the extendable support device 90 to the pivotable mounting unit 70, and thus the base unit 20, is shown in FIG. 4B.

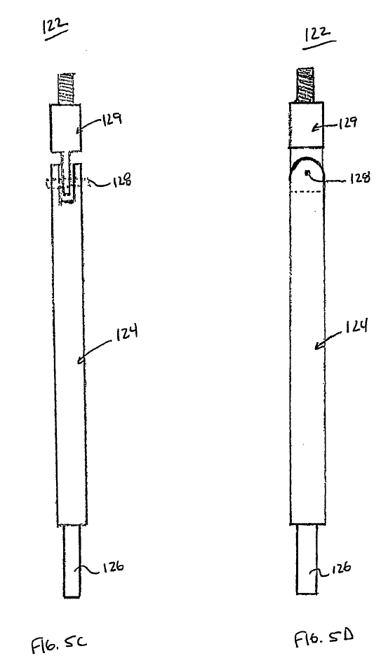

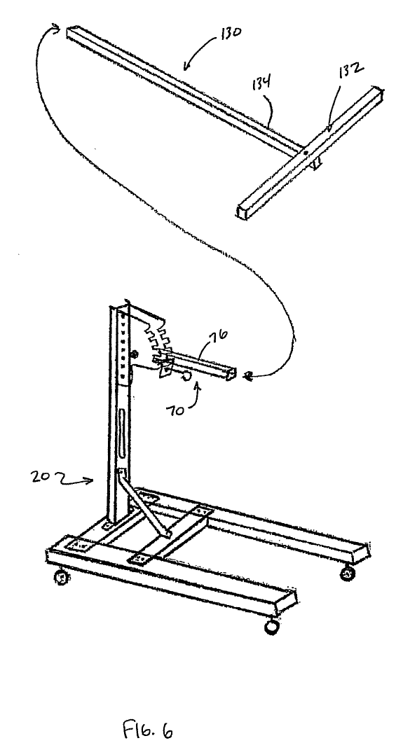

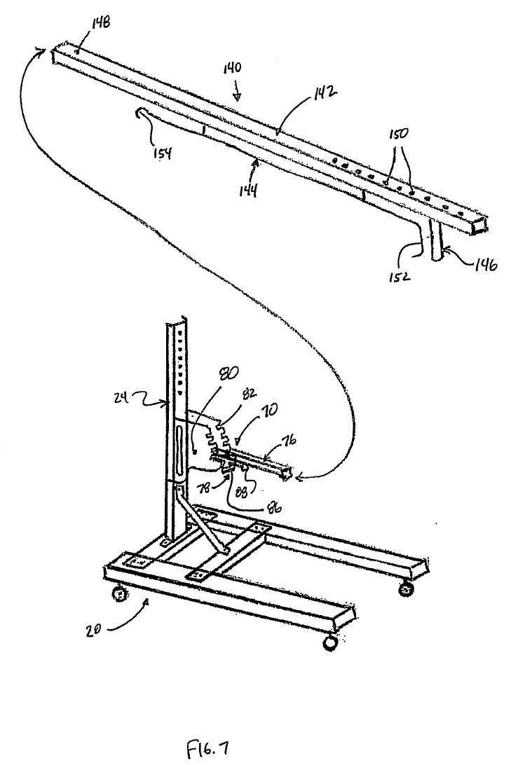

In some constructions, the extendible support device 90 is configured to selectively receive and maintain one or more tools useful for securing a part to be painted. For example, one or both of the arms 96, 98 can define a mounting bore 106 (FIG. 4A) sized to receive a corresponding feature of a separate tool. One such tool is reflected in FIG. 5A and is a spring clamp 110 useful for clamping to a part to be painted, such as the lip of a bumper cover to hold the cover firmly in place.

Another tool useful with the extendable support device 90 is shown in FIG. 5B in the form a tailgate hanger 112. The tailgate hanger 112 has a generally U-type shape, and includes a connecting member 114, an extension member 116, and a rod 118. The connecting member 114 is tubular, sized to longitudinally receive (or be received in) one of the extension arms 96, 98 (FIG. 4A) of the extendible support device 90. For example, the connecting member 114 can have a length on the order of 6 inches, and can be provided with a t-bolt 120 for securement thereof to the extendable support device 90. The extension member 116 extends in a perpendicular fashion from the connecting member 114, and can have a length on the order of 6 inches. Finally, the rod 118 extends from the extension member 116 opposite the connecting member 114, and is rigidly secured thereto. During use, two of the tailgate hangers 112 can be provided, mounted to a corresponding one of the extension arms 96, 98. The rods 118 are then available for sliding interface and capturing with the latch hole of a vehicle tailgate, thereby allowing the tailgate to hang just as it would when assembled to the vehicle.

Yet another tool useful for use in holding or mounting a vehicle part is shown in FIGS. 5C and 5D, in the form of a swivel mounting rod assembly 122. The assembly 122 includes a main rod 124 forming an end 126 sized for mounting to the extendable support device 90 (or other support device described below). An opposite end of the main rod 124 forms a swivel point 128 to which a threaded tip 129 is hingedly maintained. The threaded tip 129, in turn, is configured for threadable mounting to a part to be painted to allow the part to hinge, thereby allowing it to hang in the manner it would otherwise hang on the vehicle. For example, the swivel mounting rod assembly 122 can be useful for painting of minivan tailgates.

Yet another auxiliary support device useful with the pivotable mounting unit 70 is shown in FIG. 6 in the form of a bumper hanging assembly 130. The bumper hanging assembly 130 includes a hanger bar 132 that is connectable to the mounting bar 76 of the pivotable mounting unit 70 via a center bar 134 and locked into place with a “t” bolt (not shown). Mounting of the hanger bar 132 relative to the mounting bar 76 is adjustable, for example a slidable relationship (in and out) of the center bar 134 relative to the mounting bar 76, to accommodate different sized bumpers. The bumper hanging assembly 130 can be used in conjunction with the extendable support device 90 (described above and shown in FIG. 4A). Where employed, the hanger bar 132 holds the width of the bumper, while the support device 90 holds the ends of the bumper.

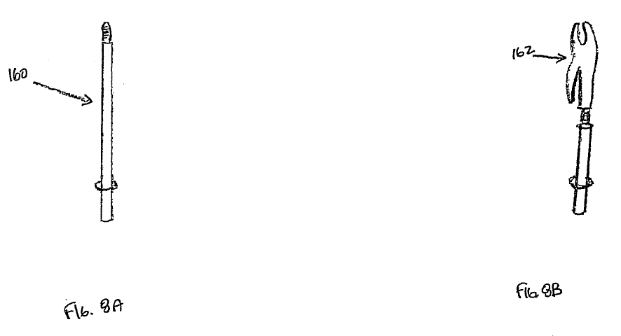

Another auxiliary support device useful with the pivotable mounting unit 70 is shown in FIG. 7 in the form of a hood hanging assembly 140, and useful as part of the painting stand systems of the present disclosure. The assembly 140 includes a center rod 142, a lever arm 144, and an optional grip 146. The center rod 142 is sized to be insertable into the mounting bar 76, and forms a hole 148 that lines up with a hole in bar 76 and is secured thereto with a pin (not shown). A plurality of mounting holes 150 are formed along at opposite end portion of the center rod 142.

The lever arm 144 is movably coupled (i.e., axially slidable) to the center rod 142, and forms a handle end 152 and a hook end 154. The hook 154 is configured to be inserted to the eye bolt 88 (or other format of the engagement member 88) of the locking mechanism 78 to adjust hood angles. More particularly, upon assembly of the center rod 142 to the mounting bar 76 such that the hole 148 is aligned with a corresponding hole (not shown) in the mounting bar 76, the hook end 154 of the lever arm 144 will align and nest with the eye bolt 88 provided with the spring loaded lever or catch 86. To alter an orientation angle of the center rod 142, and thus of the bumper hanging assembly 140, a user simply applies a pulling force onto the handle end 152 of the lever arm 144; the lever arm 144 transfers this pulling force onto the catch 86, releasing the catch 86 from the notch 82 such that the mounting bar 76/hanging assembly 140 can freely pivot or rotate about the pivot bolt 80. Subsequently, the catch 86 will engage and lock within the desired notch 82 once the lever arm 144 is released by the user. The optional grip 146 can assist the user when attempting to apply a pulling force onto the hook end 154.

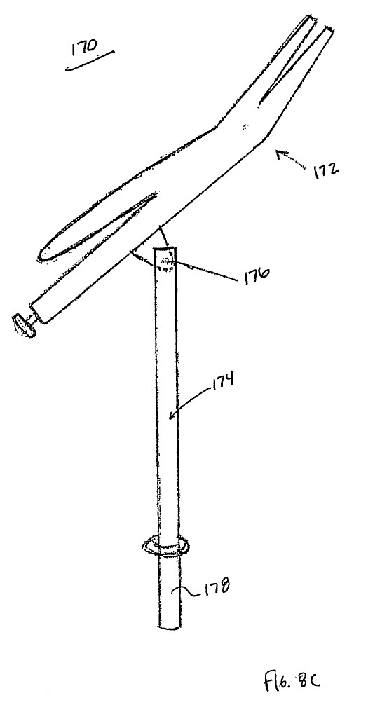

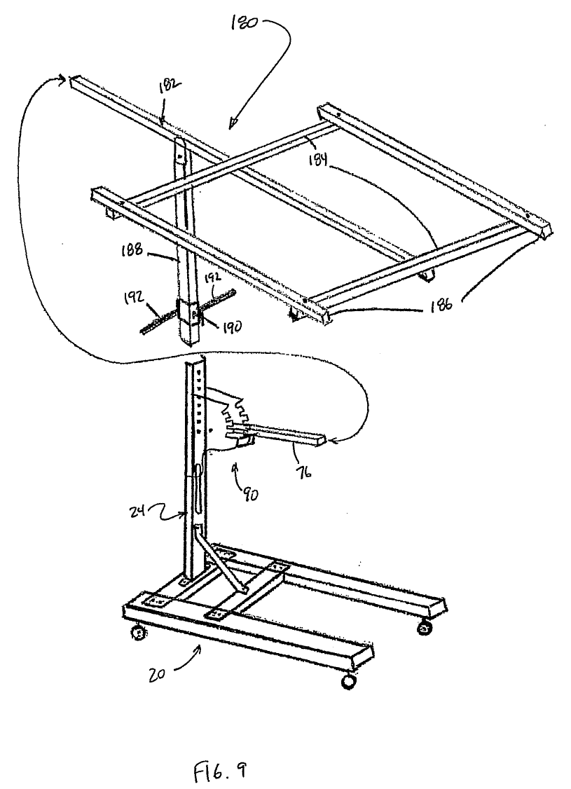

The mounting holes 150 are configured to accept one or more of the tools previously described (e.g., the spring clamp 110 of FIG. 5A, the swivel assembly 122 of FIG. 5C, etc.), or other tools such as a hood mounting rod 160 (FIG. 8A) or locking pliers 162 (FIG. 8B). Locking pliers 162 can be attached to the catch on the front bottom side of a vehicle's hood. Further, the mounting rod 160 with a threaded end threads into the hood hinge bolt hole on the bottom rear of the hood, allowing the smooth end of the mounting rod 160 to be inserted into one of the holes 150 in the outside end of the center rod 142 (or the bores 106 of the extendable support device 90 (FIG. 4A)). With two of the mounting rods 160 and the locking pliers 162 mounted to the hood, the hood can be mounted to the center rod 142 and the extendable support device 90, allowing the hood to be set at different angles during the painting process also allowing both the top and bottom of the hood to be painted at the same time.

Another, related tool is a pivoting holding device 170 shown in FIG. 8C. The device 170 includes a locking pliers 172 pivotably mounted to a rod 174 at a swivel point 176. An opposite end 178 of the rod 174 is sized for rotatable coupling to the hood hanging assembly 140 (FIG. 7) via the holes 150 (FIG. 7), the extendable support device 90 (FIG. 4A) via the bores 106 (FIG. 4A), etc. The device 170 can be used to hold any number of parts and is not limited to use with any one particular part type or shape.

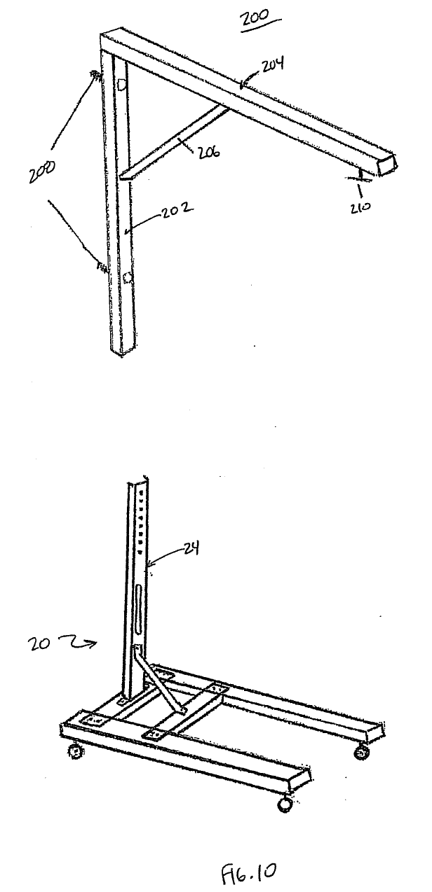

Yet another auxiliary support device useful with the pivotable mounting unit 90 as part of the painting stand system of the present disclosure is shown in FIG. 9 as a fender mounting assembly 180 and consists of a center rod 182 that inserts into mounting bar 76 and is locked into place with a “t” bolt (not shown). The center rod 182 has two framing bars 184 that are perpendicular and centered on the center rod 182. The bars 184 support two (or more) side bars 186 on their ends allowing, for example, a fender to hang on each side. All components 182-186 can be bolted together. Further, a hanging bar 188 hangs from, and pivots relative to, the center rod 182 close to the end that inserts into the mounting bar 76 and that carries an adjustable bracket assembly 190 with two adjustable shoulders 192 that are designed to, for example, hold the bottom of a fender or two fenders at once so they hang exactly as if they were on a vehicle.

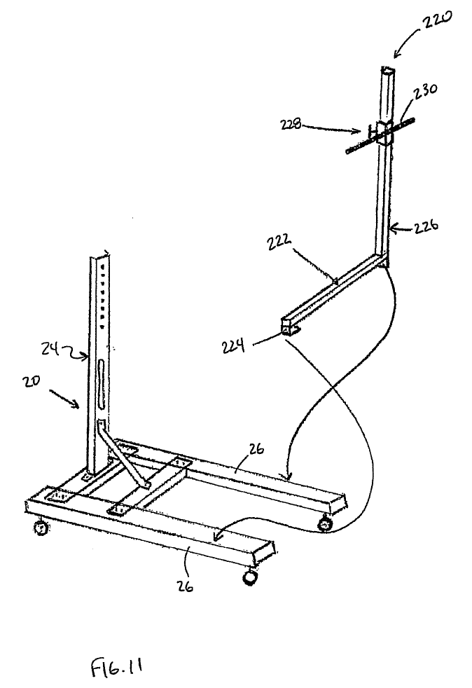

Yet another mounting unit useful with the base unit 20 as part of a painting stand system in accordance with the present disclosure is shown in FIG. 10 in the form of a fixed holder mounting unit 200. The fixed holder unit 200 can be used in place of the pivotable mounting unit 70 (FIG. 3A) where the part or accessory to be painted does not need to pivot up or down. With this in mind, the fixed holder unit 200 includes a first arm 202, a second arm 204, and a brace 206. The first arm 202 is sized for mounting to the upright post 24, for example via mounting bolts 208. The second arm 204 is rigidly secured to the first arm 202, and extends in a perpendicular fashion. The brace 206 supports the second arm 204 relative to the first arm 202, and a t-bolt 210 can be provided with the second arm 204 that facilitates coupling with a vehicle part. During use, the fixed holder unit 200 is coupled to the base unit 20, and the vehicle part to be painted is hung from the second arm 204.

Yet another mounting unit useful with the base unit 20 as part of a painting stand system in accordance with the present disclosure is shown in FIG. 11 in the form of a stabilizer mounting unit 220. The stabilizer unit 220 includes a base leg 222, one or more brackets 224, an upright leg 226, and a holder body 228. The bracket(s) 224 is fixed to, and extends from, the base leg 222, and is configured for coupling to the base unit 20, and in particular the base members 26. With this construction, then, the stabilizer unit 220 can be assembled to the base unit 20 opposite the upright post 24 to provide additional stability to the part being painted. The upright leg 226 projects from the base leg 222 in a perpendicular fashion. Finally, the holder body 228 is slidably assembled to the upright leg 226, and maintains a mounting rod 230. The holder body 228 can be vertically positioned relative to the upright leg 226 at a desired height, with the mounting rod 230 then being available for securement to the part being painted.

Painting stand systems in accordance with the present disclosure provide a marked improvement over previous designs. The base unit is uniquely configured to accept and maintain various mounting units at different vertical elevations, allowing a user to not only select the desired mounting unit format, but also to vertically locate the mounting unit, and thus a vehicle body part held by the mounting unit, at a most-convenient elevation. Further, the mounting units envisioned by the present disclosure elegantly accommodate virtually any body part shape and size, further enhancing a user's ability to easily paint any part encountered. The pivotable mounting unit provides additional advantages not heretofore recognized, including not only quick assembly to, and disassembly from, the base unit, but also simplified lowering or lifting of a body part during the painting process. Finally, the auxiliary support devices and various tools described promote desired, rigid connection to the vehicle body part, and are interchangeable, resulting in the painting stand systems having nearly universal applicability.

Although the present disclosure has been described with reference to preferred embodiments, workers skilled in the art will recognize that changes can be made in form and detail without departing from the spirit and scope of the present disclosure. For example, while the painting stand system has been described as including the base unit to which one or more of the door mounting unit, the pivotable mounting unit, the fixed holder mounting unit and the stabilizer mounting unit are removably assembled, in other embodiments, not all of the mounting units need be included. For example, in some constructions, only one of the mounting units is provided along with the base unit in forming a painting stand system in accordance with the present disclosure. Similarly, while a variety of auxiliary support devices have been described, in some embodiments, one, more, or all of the auxiliary support devices can be omitted with a painting stand system in accordance with the present disclosure. Also, it is contemplated that one or more of the tools or devices described herein can be omitted with a painting stand system in accordance with the present disclosure.

What is claimed is:

1. A painting stand system for supporting one or more vehicle body parts and accessories for spray painting, the painting stand system comprising:
a base unit including a platform frame assembly and an upright post extending vertically from the platform frame assembly to an upper end, the upright post defining an elongated inner face, a plurality openings in the inner face adjacent the upper end, and an elongated slot in the inner face between the openings and the platform frame assembly;
a pivotable mounting unit including:
a housing forming arcuately arranged notches,
at least one finger extending from the housing and sized for selectively engagement with respective ones of the openings and the slot,
a mounting bar pivotably assembled to, and extending from, the housing opposite the finger, the mounting bar terminating at a leading end,
a locking mechanism selectively securing the mounting bar relative to the housing at respective ones of the notches,
wherein the pivotable mounting unit is removably mountable to, and supported by, the upright post at a plurality of vertical locations via insertion of the finger into a selective one of the openings or the slot; and
a first auxiliary support device selectively coupled to the mounting bar, the support device configured for connection to a vehicle body part.

2. The painting stand system of claim 1, wherein the plurality of openings consists of a series of vertically aligned, equidistantly-spaced holes.

3. The painting stand system of claim 1, wherein a length of the slot is greater than a diameter of each of the openings.

4. The painting stand system of claim 1, wherein the platform frame assembly includes:
opposing base members;
at least one cross-bar interconnecting the base members, the upright post extending from the cross-bar; and
a plurality of caster wheels assembled to an underside of the base members opposite the upright post.

5. The painting stand system of claim 1, wherein the locking mechanism includes a catch and a biasing member, the catch being slidably coupled to the mounting bar, and the biasing member connected to the catch for selectively biasing the catch into engagement with respective ones of the notches.

6. The painting stand system of claim 1, wherein the first auxiliary support device is a bumper cover holding assembly including:
a center rod defining first and second ends;
a coupling member secured to the rod between the first and second ends and sized to slidably receive the leading end of the mounting bar for selectively mounting the auxiliary support device to the pivotable mounting unit;
a first extension arm slidably secured to the first end; and
a second extension arm slidably secured to the second end;
wherein a length collectively defined by the extension arms is adjustable by sliding at least one of the arms relative to the center rod.

7. The painting stand system of claim 6, wherein the first auxiliary support device further includes a clamp device selectively mountable to one of the extension arms.

8. The painting stand system of claim 7, wherein the first auxiliary support device further includes a tail gate hanger member configured for selective mounting to one of the extension arms.

9. The painting stand system of claim 1, wherein the first auxiliary support device is a bumper hanging assembly including:
a center rod defining first and second ends, the first end configured to slidably engage the leading end of the mounting bar for selectively coupling the support device to the mounting unit; and
a support arm affixed to the center rod adjacent the second end, the support arm extending perpendicular to the center rod.

10. The painting stand system of claim 1, wherein the first auxiliary support device is a hood hanging assembly including:
a center rod defining first and second ends, the first end sized to slidably interface with the leading end of the mounting bar for selectively coupling the support device to the pivotable mounting unit, the center rod forming a plurality of holes adjacent the second end;
a lever arm movably connected to the center rod and forming a handle end and a hook end, the hook end being disposed more proximate the first end of the center rod;
wherein coupling of the support device to the pivotable mounting unit includes connecting the hook end to the locking mechanism; and
a holder configured to secure a vehicle body part, the holder adapted to be selectively coupled to respective ones of the holes.

11. The painting stand system of claim 1, wherein the first auxiliary support device is a fender mounting assembly including:
a center rod defining first and second ends, the first end sized to slidably interface with the leading end of the mounting bar for slidably coupling the support device to the pivotable mounting unit;
framing bars coupled to, and extending from, the center rod adjacent the second end;
a hanging bar pivotably connected to the center rod between the first end and the framing bars; and
a bracket assembly slidably connected to the hanging bar.

12. The painting stand system of claim 11, further comprising:
a second auxiliary support device including:
a main rod defining first and second ends,
a coupling member secured to the main rod between the first and second ends and sized to slidably receive the leading end of the mounting bar for selectively mounting the second auxiliary support device to the pivotable mounting unit,
a first extension arm slidably secured to the first end, and
a second extension arm slidably secured to the second end;
wherein a length collectively defined by the extension arms is adjustable by sliding at least one of the arms relative to the center rod;
a third auxiliary support device including:
a primary rod defining first and second ends, the first end of the primary rod configured to slidably engage the leading end of the mounting bar for selectively coupling the third auxiliary support device to the mounting unit, and
a support arm affixed to the primary rod adjacent the second end, the support arm extending perpendicular to the primary rod; and
a fourth auxiliary support device including:
a base rod defining first and second ends, the first end of the base rod sized to slidably interface with the leading end of the mounting bar for selectively coupling the fourth auxiliary support device to the pivotable mounting unit, the base rod forming a plurality of holes adjacent the second end,
a lever arm movable connected to the base rod and forming a handle end and a hook end, the hook end being disposed more proximate the first end of the base rod,
wherein coupling of the fourth auxiliary support device to the pivotable mounting unit includes connecting the hook end to the locking mechanism,
a holder configured to secure a vehicle body part, the holder adapted to be selectively coupled to respective ones of the holes.

13. The painting stand system of claim 1, further comprising a door mounting unit including:
a door mounting rod defining first and second ends;
wherein the first end is sized for selective engagement with a respective one of the openings and the slot;
and further wherein the second end is configured to mate with a hinge of a vehicle door.

14. The painting stand system of claim 13, wherein the second end forms a threaded bore.

15. The painting stand system of claim 15, wherein the door mounting unit further includes:
an adapter component having a first segment forming threads for threaded engagement with the bore and a second segment for mating with a corresponding component of a hinge of a vehicle door.

16. The painting stand system of claim 1, further comprising a fixed holder unit including:
a first arm sized to be received within the upper end of the upright post for slidable coupling of the fixed holder unit to the base unit via at least one of the openings; and
a second arm affixed to, and extending perpendicularly from, the first arm.

17. The painting stand system of claim 1, further comprising a stabilizer unit including:
a base leg;
at least one bracket assembled to the base leg and configured for mounting the stabilizer unit to the platform frame assembly at a location spaced from the upright post;
an upright leg extending perpendicularly from the base leg; and
a holder body slidably coupled to the upright leg.

18. A painting stand system for supporting one or more vehicle body parts and accessories for spray painting, the painting stand system comprising:
a base unit including a platform frame assembly and an upright post extending vertically from the platform frame assembly to an upper end, the upright post defining an elongated inner face, a plurality openings in the inner face adjacent the upper end, and an elongated slot in the inner face between the openings and the platform frame assembly;
a pivotable mounting unit including:
a housing forming arcuately arranged notches,
at least one finger extending from the housing and sized for selectively engagement with respective ones of the openings and the slot,
a mounting bar pivotably assembled to, and extending from, the housing opposite the finger, the mounting bar terminating at a leading end,
a locking mechanism selectively securing the mounting bar relative to the housing at respective ones of the notches,
wherein the pivotable mounting unit is removably mountable to, and supported by, the upright post at a plurality of vertical locations via insertion of the finger into a selective one of the openings or the slot;
a door mounting unit including:
a door mounting rod defining first and second ends,
wherein the first end is sized for selective engagement with a respective one of the openings and the slot,
and further wherein the second end is configured to mate with a hinge of a vehicle door;
a fixed holder unit including:
a first arm sized to be received within the upper end of the upright post for slidable coupling of the fixed holder unit to the base unit via at least one of the openings,
a second arm affixed to, and extending perpendicularly from, the first arm; and
a stabilizer unit including:
a base leg,
at least one bracket assembled to the base leg and configured for mounting the stabilizer unit to the platform frame assembly at a location spaced from the upright post,
an upright leg extending perpendicularly from the base leg,
a holder body slidably coupled to the upright leg.

19. The painting stand system of claim 18, further comprising:
a first auxiliary support device including:
a center rod defining first and second ends,
a coupling member secured to the rod between the first and second ends and sized to slidably receive the leading end of the mounting bar for selectively mounting the first auxiliary support device to the pivotable mounting unit,
a first extension arm slidably secured to the first end,
a second extension arm slidably secured to the second end,
wherein a length collectively defined by the extension arms is adjustable by sliding at least one of the arms relative to the center rod;
a second auxiliary support device including:
a main rod defining first and second ends, the first end of the main rod configured to slidably engage the leading end of the mounting bar for selectively coupling the second auxiliary support device to the mounting unit, and
a support arm affixed to the main rod adjacent the second end of the main rod, the support arm extending perpendicular to the main rod;
a third auxiliary support device including:
a primary rod defining first and second ends, the first end of the primary rod sized to slidably interface with the leading end of the mounting bar for selectively coupling the third auxiliary support device to the pivotable mounting unit, the primary rod forming a plurality of holes adjacent the second end,
a lever arm movable connected to the primary rod and forming a handle end and a hook end, the hook end being disposed more proximate the first end of the primary rod,
wherein coupling of the third auxiliary support device to the pivotable mounting unit includes connecting the hook end to the locking mechanism,
a holder configured to secure a vehicle body part, the holder adapted to be selectively coupled to respective ones of the holes; and
a fourth auxiliary support device including:
a base rod defining first and second ends, the first end of the base rod sized to slidably interface with the leading end of the mounting bar for slidably coupling the fourth auxiliary support device to the pivotable mounting unit,
framing bars coupled to, and extending from, the base rod adjacent the second end of the base rod,
a hanging bar pivotably connected to the base rod between the first end base rod and the framing bars,
a bracket assembly slidably connected to the hanging bar.
